(19) United States
(12) Patent Application Publication
(10) Pub. No.: US 2011/0283499 A1
(43) Pub. Date: Nov. 24, 2011

(54) METHOD OF, AND APPARATUS FOR, PRODUCING COMPOSITE ARTICLES

(76) Inventor: Jan Petrus Human, Somerset West (ZA)

(21) Appl. No.: 13/119,652

(22) PCT Filed: Sep. 14, 2009
(86) PCT No.: PCT/IB2009/054004

§ 371 Date: Aug. 16, 2011

(30) Foreign Application Priority Data
Sep. 18, 2008 (ZA) 2008/08044

(51) Int. Cl. H01M 4/04; H01M 4/72

(52) U.S. Cl. 29/2; 29/527.1

(57) ABSTRACT

Apparatus for manufacturing a composite structure of metal or other material and injection moulded synthetic plastics is disclosed. The apparatus comprises three components (12, 14, 16) which can be moved between an open position in which they are spaced apart and a closed position in which they are forced into contact. The centre component (14) has openings (30) in it and the outer component (16) has protrusions (36) which enter the openings (30) in the component (12) and punch a strip (40) which is between the two components. The punched out element is forced through the centre component (14) into a moulding cavity defined by the components (12, 14) and the front faces of the protrusions (36). A plastics material injection point (18) is provided in the component (12).

### FIELD OF THE INVENTION

THIS INVENTION relates to a method of producing composite components which method is particularly, but not exclusively, intended for use in the production of grids for secondary batteries. The invention also relates to apparatus for producing composite components.

### BACKGROUND TO THE INVENTION

A widely used form of battery is the lead acid battery. It is this battery that is used to start internal combustion engines and is also used as a standby power source.

The basic component of the lead acid battery is the battery grid. Conventionally this comprises a rectangular frame, an array of intersecting bars filling the space bounded by the frame and providing a plurality of openings, and a terminal lug protruding from the frame. The frame, bars and lug are all of lead.

Lead is a malleable material and has little resistance to bending and distortion. To impart stiffness to the plate, additives such as calcium and antimony are added to the lead before the battery plate is cast or otherwise formed. The additives are also intended to improve other properties of the lead and particularly to facilitate working with it.

The electrochemically active material is applied to the grid by a procedure known as pasting. The material enters the openings of the grid and forms what are called pellets. A pasted grid forms a battery plate. A plate with pellets of electrochemically positive material, a plate with pellets of electrochemically negative material and a porous separator form a cell.

Various constructions have been proposed which are intended to enable pure lead, instead of lead with additives, to be used for the purpose of fabricating battery plates. The constructions proposed provide an acid resistant support for the lead. The following are examples of prior proposals:—

U.S. Pat. No. 3,556,854—Wheadon proposes a plastic material grid to which lead ribbons are fitted. Fitting the ribbons to the grid is a labour intensive operation.

U.S. Pat. No. 3,738,871—Scholle. In this specification a construction comprising a plastics material frame with a grid of lead wires extending across the opening bounded by the frame is disclosed.

U.S. Pat. No. 3,956,012—Scholle. In this specification it is proposed that the frame and a grid within the frame should be of plastics material. A lead strand is supported by the grid.

U.S. Pat. No. 4,160,309—Scholle. The inventor in this specification proposes a composite lead and a plastics material battery plate and that the lead and plastics material be sequentially injection moulded in the same mould. Controlling the feed of two types of molten moulding material in a single mould is clearly technically complex.

U.S. Pat. No. 3,944,431—Ikari. In the construction proposed in this specification the lead is in the form of wires which are wound around elongate non-conductive supporting elements which span across a frame.

The present invention seeks to provide a method of producing a grid of composite construction in a mould thereby avoiding the labour costs inherent in assembly operations and to enable a satisfactory rate of production of grids to be attained.

There are products which comprise an injection moulded part in which another component is embedded, either entirely or partially. The method and apparatus of the present invention are able to produce such composite components.

### BRIEF DESCRIPTION OF THE INVENTION

According to one aspect of the present invention there is provided a method of manufacturing a composite battery grid which method comprises;—

feeding a sheet of electrically conductive material into a gap defined by a first component having protrusions and one of the faces of a second component which second component has openings in it matching the protrusions, the other face of said second component and the protrusions having grooves therein and there being a third component which is on the opposite side of said second component to the first component and which also has grooves in it;

moving the first and second components together so that the protrusions of said first component enter the openings of the second component and punch out that part of said metal sheet which is in register with the openings and force such part through the second component and into a moulding cavity defined by the protrusions of the first component, the second component and the third component; and

moulding a structure for supporting and locating the punched out part of said metal sheet by injecting synthetic plastics material into said moulding cavity.

The method can include the further steps of;—

separating said first and second components and said second and third components after injection moulding said structure;

providing said metal sheet in strip form; and

advancing said sheet subsequent to separating said first and second components.

Said metal part can include one or more tabs which protrude from the moulded structure to form a battery lug. Said grid preferably comprises a frame and plurality of filaments spanning across the frame and defining with said punched metal part openings for receiving pellets of electrochemically active material.

Preferably said metal part comprises a column and a series of parallel sections joined at their ends to said columns thereby to constitute a comb, said parallel sections crossing said filaments whereby said filaments and said parallel sections define said openings.

Said first component can have first and second sets of protrusions and said second component can have first and second sets of matching openings whereby two discrete, separate metal parts are punched out as said protrusions enter said openings.

Each of said metal parts can include a tab which protudes from said moulded structure, each tab constituting a battery lug.

The battery grids that are produced are pasted with electrochemically active material which enters said openings whereby the grids become battery plates.

According to another aspect of the present invention there is provided apparatus for producing a composite battery grid, the apparatus comprising:—

a first component having protrusions;

a second component having openings in it that match the protrusions of the first component;

means for displacing said first and second components relatively to one another between an open position in which the components are spaced apart and a closed position in which said protrusions are in said openings;

means for feeding a metal sheet between said components whilst they are spaced apart whereby, as said first and second components move to the closed position, the part of the sheet which overlies said openings is punched out and pushed through the second component;

grooves in said protrusions and in that surface of said second component which faces away from the first component;

a third component having grooves in that surface thereof which faces said surface of the second component;

means for displacing said components relatively to one another between an open position in which said components are spaced apart and a closed position in which said protrusions, said second component and said third component bound a moulding cavity which receives said metal part punched out by the protrusions of the first component; and

means for injecting synthetic plastics material into said moulding cavity to form a structure which supports and locates said metal part.

Said apparatus can further include means for advancing a metal strip into the gap between said first and second components to introduce an unapertured portion of the strip between said first and second components and remove the portion of the strip that was punched when the protrusions last entered the openings.

Said openings and protrusions can be configured to produce a tab which protrudes from the moulded structure and forms a battery lug.

Said grooves of the protrusions, the second and third components can be such that the moulded structure comprises a frame and a plurality of filaments spanning across the frame, there being openings for receiving pellets of electrochemically active material.

Preferably said metal part comprises a column and a series of parallel sections joined at their ends to the column to constitute a comb, said parallel sections crossing said filaments thereby to define said openings between said filaments and said sections.

Said first component can have first and second sets of protrusions and said second component can have first and second sets of openings whereby two discrete, separate metal parts are punched out as the first and second sets of protrusions enter the first and second sets of openings.

Said protrusions and openings can be that each punched metal part includes a tab which protrudes from the moulded structure thereby to provide two battery lugs.

According to a further aspect of the present invention there is provided apparatus for producing a composite structure comprising:—

a first component having protrusions;

a second component having openings in it that match the protrusions of the first component;

means for displacing said first and second components relatively to one another between an open position in which the components are spaced apart and a closed position in which said protrusions are in said openings;

means for feeding a sheet of material between said components whilst they are spaced apart whereby, as said first and second components move to the closed position, the part of the sheet which overlies said openings is punched out and pushed through the second component;

a third component having a surface which faces said surface of the second component;

means for displacing said first, second and third components relatively to one another between an open position in which said components are spaced apart and a closed position in which said components bound a moulding cavity which receives said part punched out by the protrusions of the first component; and

means for injecting synthetic plastics material into said moulding cavity to form a structure which supports and locates said punched part.

According to a still further aspect of the present invention there is provided a method of manufacturing a composite component which method comprises.

feeding a sheet of material into a gap defined by a first component having protrusions and one of the faces of a second component which second component has openings in it matching the protrusions, providing a third component on the opposite side of said second component to the first component, moving the first and second components together so that the protrusions of said first component enter the openings of the second component and punch out that part of said sheet which is in register with the openings and force said part through the second component and into a moulding cavity defined by the second component, the third component and the protrusions of the first component, and moulding a structure for supporting and locating the punched out part of said sheet by injecting synthetic plastics material into said moulding cavity.

### BRIEF DESCRIPTION OF DRAWINGS

For a better understanding of the present invention, and to show how the same may be carried into effect, reference will now be made, by way of example, to the accompanying drawings in which:—

FIGS. 1 and 2 are diagrammatic pictorial views of apparatus for manufacturing a battery grid;

FIG. 3 is a pictorial view similar to that of FIGS. 1 and 2 but taken from the opposite direction;

FIGS. 4 and 5 illustrates details of the construction within the circles designated A4 and A5 in FIG. 1;

FIGS. 6 and 7 illustrate details of the construction within the circles designated A6 and A7 in FIG. 2;

FIG. 8 is an elevation of a battery grid in accordance with the present invention;

FIG. 9 is a detail of the battery grid;

FIG. 10 is an edge view of the grid of FIG. 8;

FIG. 11 is a pictorial view of the battery grid; and

FIGS. 12 and 13 are pictorial views of the top left hand corner and bottom left hand corner of the grid of FIG. 11, FIGS. 12 and 13 being to a larger scale than FIG. 11.

### DETAILED DESCRIPTION OF THE DRAWINGS

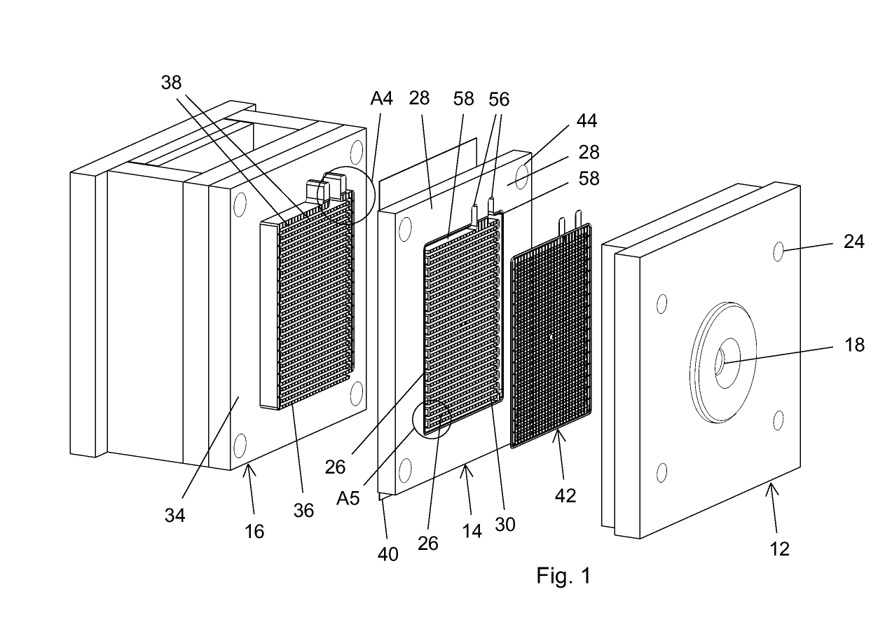

Referring firstly to FIGS. 1, 2 and 3, the apparatus 10 illustrated comprises first, second and third components designated 12, 14 and 16.

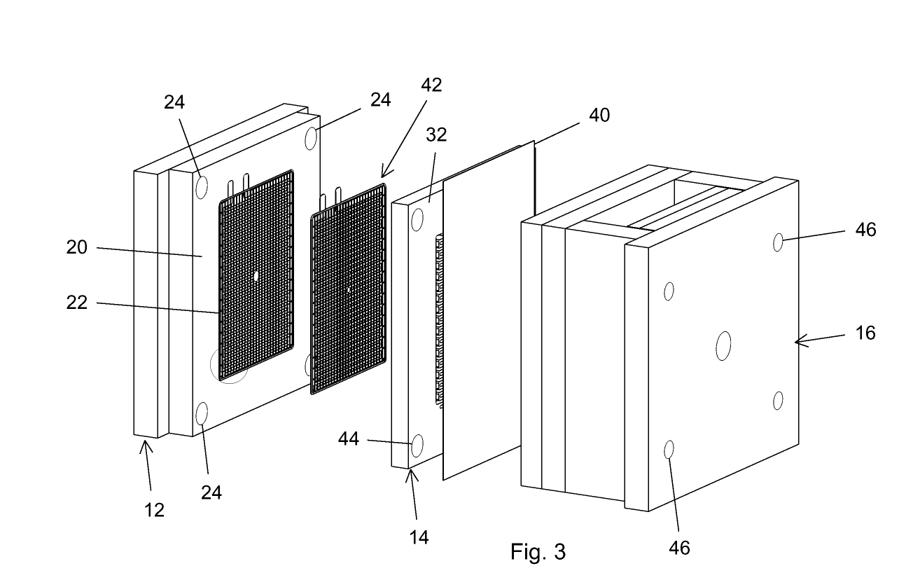

The component 12 is a fixed component and has, at the centre thereof, an injection point 18 for synthetic plastics material. The front surface 20 of the component 12 (see FIG. 3) has grooves 22 therein which will be described in more detail hereinafter. The holes 24 in the corners of the component 12 receive the fixed guide bars (not shown) along which the components 14, 16 move during use of the apparatus.

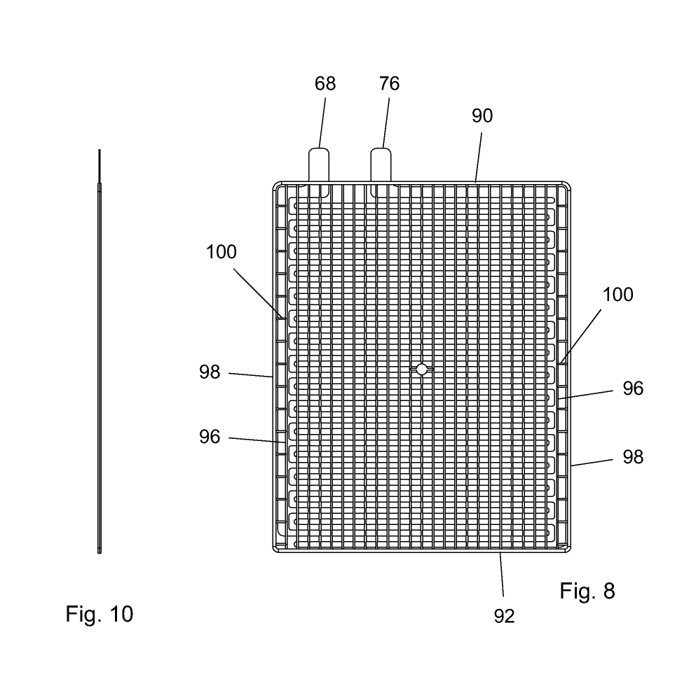

In the description of FIGS. 1 to 7, the above mentioned grooves 22, and various other grooves, will be referred to. However, the arrangement of these will be best understood from the description of FIGS. 8 to 13.

The component 14 has grooves 26 (FIG. 1) cut into that surface 28 thereof which faces the surface 20 of the component 12.

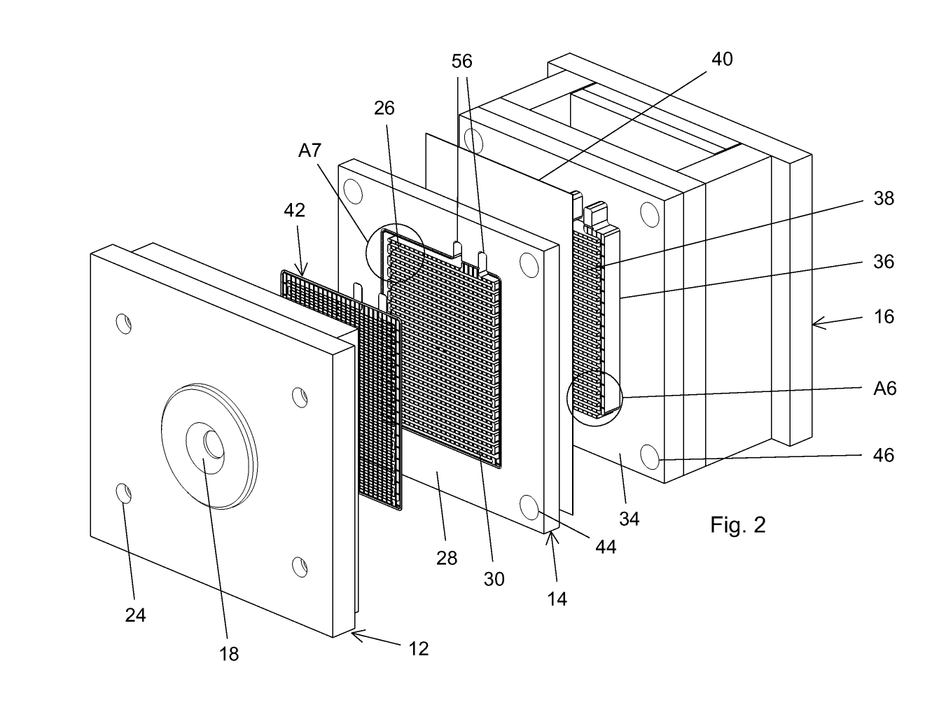

The component 14 has through openings 30. These openings pass through the component 14 from the surface 28 (FIGS. 1 and 2) to the opposite surface 32 (FIG. 3). The openings 30 can be in the form of a single set of openings but are preferably constituted by two sets of openings as will be described hereinafter.

The component 16 has a front surface 34 (FIGS. 1 and 2) and protrusions 36 standing proud of the surface 34. The arrangement of the protrusions 36 matches the arrangement of the openings 30 in the component 14. The front surfaces of the protrusions have vertically extending grooves 38 in them.

Reference numeral 40 designates a lead sheet which is in the gap between the components 14 and 16 and reference numeral 42 designates a moulded battery grid. Numerals 44 and 46 designate holes in the components 14 and 16 through which the guide bars pass.

In use of the apparatus, after the lead sheet 40, has been positioned as shown, the components 12, 14 and 14, 16 are brought into face to face contact. Upon the surface 20 of the component 12 contacting the surface 28 of the component 14 a mould cavity is partially formed by the grooves 22, 26.

The protrusions 36 approach the openings 30 as the components 14, 16 are moved into proximity with one another. As the protrusions 36 enter the openings 30 the lead sheet 40 is punched, that part of the sheet which was in register with the openings 30 being pushed through the component 14 and into the mould cavity between the components 12, 14. The front surfaces of the protrusions 36 and the grooved front surface of the component 14 are in alignment when the protrusions 36 have entered the openings 30 to the maximum extent possible. The grooves 26 in the surface 28 and the grooves 38 in the front surfaces of the protrusions 36 together match the grooves 22 in the surface 20 of the component 12 and the three sets of grooves together define a moulding cavity. The punched out part of the lead sheet is in the moulding cavity.

The arrangement of the grooves 22, 26 and 38 will be described in more detail hereinafter.

Synthetic plastics material is then forced in via the injection point 18 to form a structure which locates and supports the punched out part of the lead sheet.

The sheet 40 is preferably part of a strip which extends both above and below the components 12, 14 and 16. The strip can be on a roll (not shown) which is above the components 12, 14 and 16. Feed means (not shown) are provided for pulling the strip down each time that the components 14, 16 separate. This brings an unapertured portion of the strip into the gap between the components 14, 16 and removes the part of the strip that was punched when the components 14, 16 were last moved into contact.

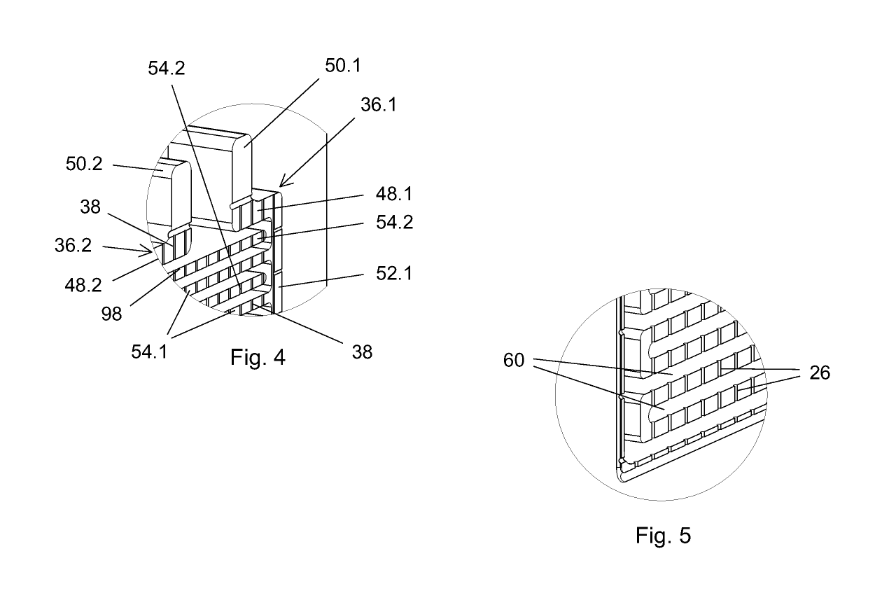

Referring now to FIG. 4 , the protrusions 36 are constituted by two sets of protrusions designated 36.1 and 36.2. The set of protrusions 36.1 comprises a top bar 48.1, a block 50.1 protruding upwardly from the bar 48.1, a vertical column 52.1 extending downwardly from the bar 48.1, and a series of vertically spaced horizontals 54.1. Each horizontal 54.1 is joined to the vertical column 52.1.

The set of protrusions 36.2 likewise comprises a top bar 48.2, a block 50.2, a vertical column (not visible in FIG. 4) and a series of parallel horizontals 54.2. The horizontals are each joined at one end to the column thereby to form a comb. The horizontals 54.2 stop short of the column 52.1 and alternate with the horizontals 54.1. The horizontals 54.1 likewise stop short of the vertical column of the protrusion set 36.2.

The top bars, the vertical columns and the horizontals of the sets of protrusions 36.1 and 36.2 have the grooves 38 therein. All the grooves extend vertically. There are no grooves in the blocks 50.1 and 50.2.

The component 14 (see FIGS. 1, 2, 5 and 7) comprises vertically elongate slots 56 for receiving the blocks 50.1 and 50.2, elongate horizontal slots 58 for receiving the bars 48.1 and 48.2, horizontal slots 60 for receiving the horizontals 54.1 and 54.2 and vertical slots 62 for receiving the vertical column 52.1 and its counterpart forming part of the protrusion set 36.2. The arrangement of the slots gives rise to two sets of openings which match the shape of the two sets of protrusions 36.1 and 36.2.

The moulded structure produced will be described in more detail hereinafter, and this description will have the effect of also describing the grooves in the components 12, 14 and 16.

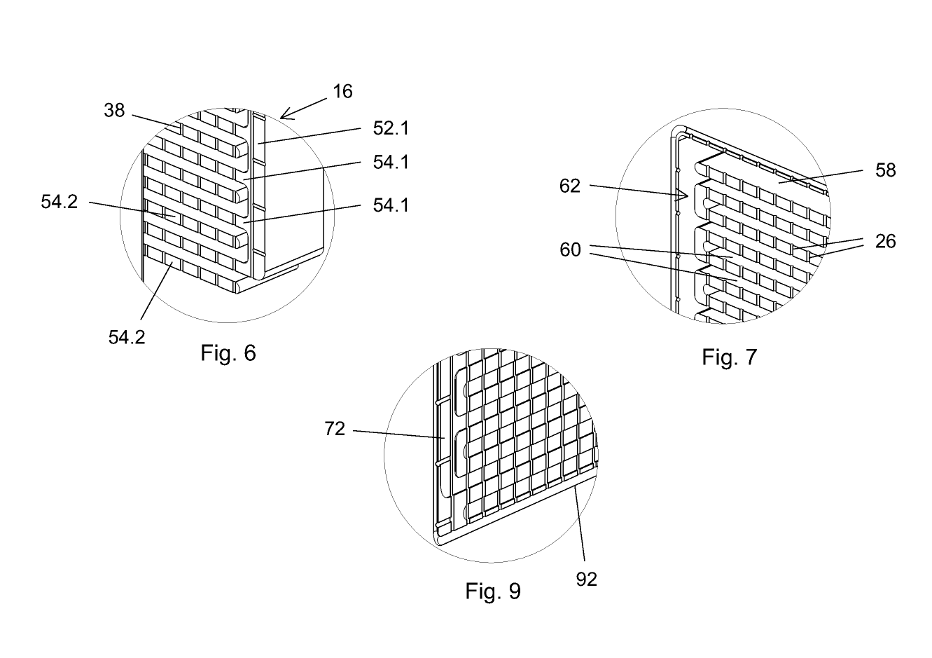

FIGS. 6 and 7 illustrate in more detail the grooves 38 which are formed in the front faces of the protrusions 36.1 and 36.2 (FIG. 6) and the grooves 26 in those parts of the component 14 which remain after the slots 60 have been cut (FIG. 7). FIG. 7 illustrates the appearance of the rear surface of the component 14. The vertical and horizontal slots 60, 62 which form part of the openings 30 are illustrated. The slots 56, 58 for receiving the top bars 48.1, 48.2 and the blocks 50.1, 50.2 are not shown in this Figure.

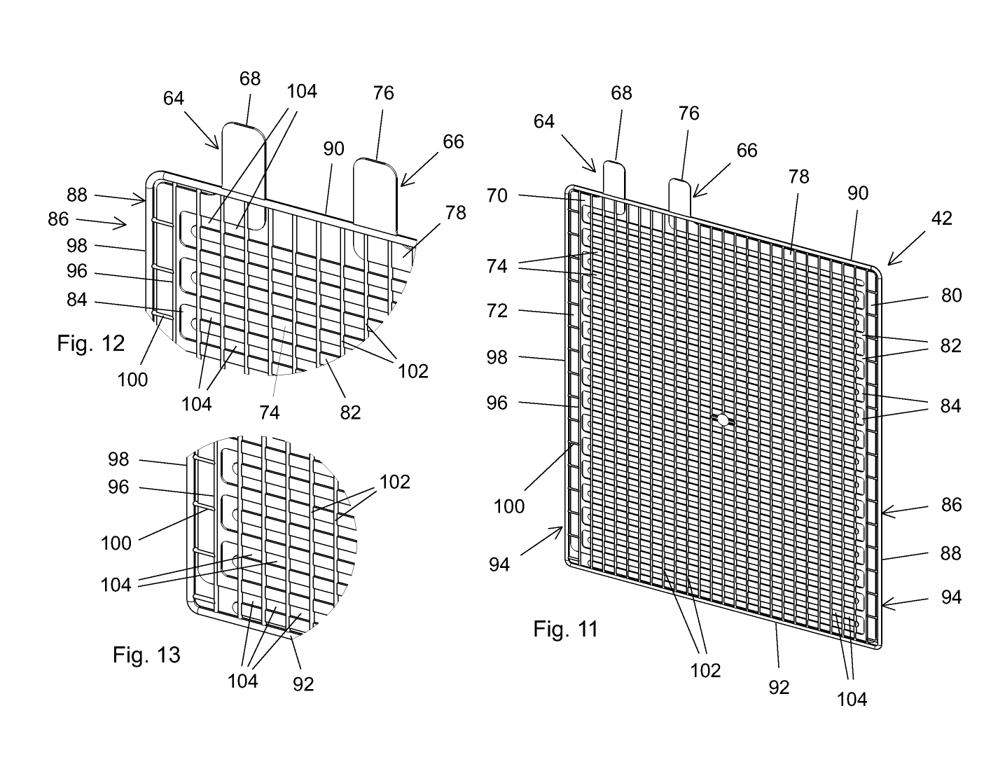

FIGS. 8 to 13 illustrate the construction of a battery grid produced in the apparatus of FIGS. 1 to 7. Two electrodes of sheet lead are shown (see particularly FIG. 11), these being designated 64 and 66. The electrode 64 includes a battery lug 68, a short upper bar 70, a vertical column 72 and a plurality of horizontal fingers 74 each joined at one end to the column. The electrode 66 comprises a battery lug 76, a longer upper bar 78, a vertical column 80 and a plurality of horizontal fingers 82. The fingers 74 alternate with the fingers 82 and all the fingers stop short of the other vertical column. As a consequence of this arrangement gaps 84 are formed between the two electrodes 64, 66, the gaps 84 following a zig zag path. The two columns and associated fingers together constitute two combs.

The moulded structure of the grid 42 is designated 86 and comprises a frame 88 having upper and lower horizontals 90 and 92 and verticals 94. Each vertical 94 comprises an inner stile 96, an outer stile 98, and rungs 100 joining the stiles 96, 98. The upper and lower horizontals 90, 92 are joined by a series of parallel filaments 102. Each filament 102 spans across the gaps 84 and across the fingers 74 and 82. Each filament is solid where it traverses a gap 84 and split to lie on each side of the lead where it traverses a finger 74, 82. In FIGS. 9 and 11 to 13 the reference numerals 104 designates the openings which are bounded by the fingers and the filaments and which receive the electrochemically active material to form the pellets.

The diameters of the upper and lower horizontals 90, 92 and the stiles 98 are the same. The stiles 96 and filaments 102 are of smaller diameter. The grid can thus be pasted to a thickness equal to the larger diameter so that the stiles 96, filaments 102 and the electrodes 64, 66 are entirely embedded in the paste. The horizontals 90 and 92, the stiles 98 forming the perimeter of the frame and the lugs 68, 76 are not embedded in the paste.

By pasting the grid with positive or negative electrochemically active material a battery plate with either two anodes or two cathodes can be produced. By removing one of the lugs 68 or 76 and electrically connecting the electrodes 64, 66, a battery plate with a single anode or a single cathode can be produced.

In the form described and illustrated the apparatus is adapted to produce a battery grid having a lead component and a plastic component.

By replacing the lead sheet 40 by a sheet of any material that can be punched, by appropriately shaping the protrusions and matching openings and appropriately configuring those faces of the components 12, 14 and 16 which bound the mould cavity, composite structures of any desired format can be produced. The sheet can be of metal such as brass or copper, of synthetic plastics material, of fibreglass or of any other material that it is desired to embed partially or wholly in synthetic plastics material.

If material such as brass or copper is used, it can be in the form of a ribbon. Other materials, such as aluminium foil, can be in the form of a web which is provided in rolled form. The term sheet as used herein is to be construed as covering all such forms of material. The essential feature of the material is that it is capable of being punched by the protrusions.

1. A method of manufacturing a composite battery grid which method comprises:
feeding a sheet of electrically conductive material into a gap defined by a first component having protrusions and one of the faces of a second component which second component has openings in it matching the protrusions, the other face of said second component and the protrusions having grooves therein and there being a third component which is on the opposite side of said second component to the first component and which also has grooves in it;
moving the first and second components together so that the protrusions of said first component enter the openings of the second component and punch out that part of said metal sheet which is in register with the openings and force such part through the second component and into a moulding cavity defined by the protrusions of the first component, the second component and the third component; and
moulding a structure for supporting and locating the punched out part of said metal sheet by injecting synthetic plastics material into said moulding cavity.

2. A method as claimed in claim 1 and including the further steps of:
separating said first and second components and said second and third components after injection moulding said structure;
providing said metal sheet in strip form; and
advancing said sheet subsequent to separating said first and second components.

3. A method as claimed in claim 1 in which the metal part includes one or more tabs which protrude from the moulded structure to form a battery lug.

4. A method as claimed in claim 1, wherein said grid comprises a frame and plurality of filaments spanning across the frame and defining, with said punched metal part openings for receiving pellets of electrochemically active material.

5. A method as claimed in claim 1, Wherein said metal part comprises a column and a series of parallel sections joined at their ends to the column thereby to constitute a comb, said parallel sections crossing said filaments whereby said filaments and said parallel sections define said openings.

6. A method as claimed in claim 1, wherein said first component has first and second sets of protrusions and said second component has first and second sets of matching openings Whereby two discrete, separate metal parts are punched out as said protrusions enter said openings.

7. A method as claimed in claim 6, wherein each of said metal parts includes a tab which protrudes from said moulded structure, each tab constituting a battery lug.

8. A method as claimed in claim 1, and including the step of pasting the battery grids with electrochemically active material Which enters said openings whereby the grids become battery plates.

9. Apparatus for producing a composite battery grid, the apparatus comprising:
a first component having protrusions;
a second component having openings in it that match the protrusions of the first component;
means for displacing said first and second components relatively to one another between an open position in which the components are spaced apart and a closed position in which said protrusions are in said openings;
means for feeding a metal sheet between said components whilst they are spaced apart whereby, as said first and second components move to the closed position, the part of the sheet which overlies said openings is punched out and pushed through the second component;
grooves in said protrusions and in that surface of said second component which faces away from the first component;
a third component having grooves in that surface thereof which faces said surface of the second component;
means for displacing said components relatively to one another between an open position in which said components are spaced apart and a closed position in which said protrusions, said second component and said third component bound a moulding cavity which receives said metal part punched out by the protrusions of the first component; and
means for injecting synthetic plastics material into said moulding cavity to form a structure which supports and locates said metal part.

10. Apparatus as claimed in claim 9 and further including, means for advancing a metal strip into the gap between said first and second components to introduce an unapertured portion of the strip between said first and second components and remove the portion of the strip that was punched when the protrusions last entered the openings.

11. Apparatus as claimed in claim 9, wherein said openings and protrusions are configured to produce a tab which protrudes from the moulded structure and forms a battery lug.

12. Apparatus as claimed in claim 9, wherein said grooves of the protrusions, the second and the third components are such that the moulded structure comprises a frame and a plurality of filaments spanning across the frame, there being openings for receiving pellets of electrochemically active material.

13. Apparatus as claimed in claim 9 wherein said rueful part comprises a column and a series of parallel sections joined at their ends to the column to constitute a comb, said parallel sections crossing said filaments thereby to define said openings between said filaments and said sections.

14. Apparatus as claimed in claim 9, wherein said first component has first and second sets of protrusions and said second component has first and second sets of openings whereby two discrete, separate metal parts are punched out as the first and second sets of protrusions enter the first and second sets of openings.

15. Apparatus as claimed in claim 14, wherein said protrusions and openings are such that each punched metal part includes a tab Which protrudes from the moulded structure thereby to provide two battery lugs.

16. Apparatus for producing a composite structure comprising:
a first component having protrusions;
a second component having openings in it that match the protrusions of the first component;
means for displacing said first and second components relatively to one another between an open position in which the components are spaced apart and a closed position in which said protrusions are in said openings
means for feeding a sheet of material between said components whilst they are spaced apart whereby, as said first and second components move to the closed position, the part of the sheet which overlies said openings is punched out and pushed through the second component;
a third component having a surface which faces said surface of the second component;
means for displacing said first, second and third components relatively to one another between an open position in which said components are spaced apart and a closed position in which said components bound a moulding cavity which receives said part punched out by the protrusions of the first component; and
means for injecting synthetic plastics material into said moulding cavity to form a structure which supports and locates said punched part.

17. A method of manufacturing a composite structure which method comprises feeding a sheet of material into a gap defined by a first component having protrusions and one of the faces of a second component which second component has openings in it matching the protrusions, providing a third component on the opposite side of said second component to the first component, moving the first and second components together so that the protrusions of said first component enter the openings of the second component and punch out that part of said sheet which is in register with the openings and force said part through the second component and into a moulding cavity defined by the second component, the third component and the protrusions of the first component, and moulding a structure for supporting and locating the punched out part of said sheet by injecting synthetic plastics material into said moulding cavity.

18. A method as claimed in claim 2. in which the metal part includes one or more tabs which protrude from the moulded structure to form a battery lug.

19. A method as claimed in claim 2, wherein said grid comprises a frame, and plurality of filaments spanning across the frame and defining with said punched metal part openings for receiving pellets of electrochemically active material.

20. A method as claimed in claim 3, wherein said grid comprises a frame and plurality of filaments spanning across the frame and defining with said punched metal part openings for receiving pellets of electrochemically active material.
